(19) United States
(12) Patent Application Publication
(10) Pub. No.: US 2019/0295085 A1
(43) Pub. Date: Sep. 26, 2019

(54) IDENTIFYING FRAUDULENT TRANSACTIONS

(71) Applicant: CA, Inc., New York, NY (US)

(72) Inventors: Himanshu ASHIYA, Bangalore (IN); Atmaram Prabhakar SHETYE, Bangalore (IN)

(73) Assignee: CA, Inc.

(21) Appl. No.: 15/934,270

(22) Filed: Mar. 23, 2018

(51) Int. Cl. G06Q 20/40; G06Q 20/38; G06F 15/18

(52) U.S. Cl. CPC G06Q 20/4016; G06F 15/18; G06Q 20/3823

(57) ABSTRACT

A method includes determining, within a plurality of feature vectors corresponding to a plurality of transactions, a correlation between values of particular features in the plurality of feature vectors that distinguish at least a subset of the transactions as fraudulent. Each feature vector comprises a plurality of features having values that describe the feature vector's corresponding transaction. The method further includes generating a triggering criteria for identifying suspicious transactions based on the values of the particular features. The method additionally includes, in response to receiving a request to approve a new transaction, determining that attributes of the new transaction meet the triggering criteria, and transmitting a request for authentication of an account holder associated with the new transaction.

### BACKGROUND

The present disclosure relates to identifying fraudulent transactions in a payment processing system.

### BRIEF SUMMARY

According to an aspect of the present disclosure, a method includes by a computing device, determining, within a plurality of feature vectors corresponding to a plurality of transactions, a correlation between values of particular features in the plurality of feature vectors that distinguish at least a subset of the transactions as fraudulent. Each feature vector comprises a plurality of features having values that describe the feature vector's corresponding transaction. The method also includes generating a triggering criteria for identifying suspicious transactions based on the values of the particular features. The method further includes, in response to receiving a request to approve a new transaction, determining that attributes of the new transaction meet the triggering criteria, and transmitting a request for authentication of an account holder associated with the new transaction.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a high-level diagram of a computer network.

FIG. 2 is a high-level block diagram of a computer system.

FIG. 3 is a flowchart for identifying fraudulent transactions illustrated in accordance with a non-limiting embodiment of the present disclosure.

FIG. 4 is a table of sample feature vector values for identifying fraudulent transactions illustrated in accordance with a non-limiting embodiment of the present disclosure.

FIG. 5 is example pseudocode implementing rules for identifying fraudulent transactions in accordance with a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

Consumers expect safe, transparent online shopping experiences. However, authentication requests may cause those consumers to abandon certain transactions, resulting in lost interchange fees for the issuer. Card issuers often strive to minimize customer friction and provide security for Card Not Present (CNP) payment transactions to protect cardholders from fraud and reduce the liability associated with losses stemming from those fraudulent transactions. payment processing agents strive to minimize cardholder abandonment, which could potentially result in lost interchange fee revenue. Additionally, when customers are inundated with authentication requests for a particular account, those customers may seek alternative forms of payment, leading to additional lost interchange fee revenue. To this same effect, high volumes of customer service inquiries can increase operational costs and impact budgets.

Payment processors also seek to reduce instances of “fully authenticated” fraud. This type of fraud occurs in the face of enhanced authentication procedures as a result of the fraudulent participant capturing the target's full authentication information. These types of fraud levy steep costs on payment processing agents including liability for the fraudulent payment to the merchant or cardholder and operational expenses incurred from processing fraudulent transactions.

In certain embodiments, risk analytics platforms provide transparent, intelligent risk assessment and fraud detection for CNP payments. Such a platform makes use of advanced authentication models and flexible rules to examine current and past transactions, user behavior, device characteristics and historical fraud data to evaluate risk in real time. The calculated risk score is then used in connection with payment processing agent policies to automatically manage transactions based on the level of risk inherent in each transaction. For example, if the transaction is determined to be low risk, the systems and rules allow the transactions to proceed, thus allowing the majority of legitimate customers to complete their transactions without impact. Similarly, potentially risky transactions are immediately challenged with additional authentication steps. In certain embodiments, those risky transactions can be denied. A comprehensive case management system provides transparency to all fraud data allowing analysts to prioritize and take action on cases. In particular embodiments, a database of fraudulent activity is provided for inquiry and access of additional information regarding suspicious or fraudulent transactions. Thus, historical fraudulent data is readily queryable and made available to payment processing agents to support customer inquiries.

In certain embodiments, the risk analytics system uses sophisticated behavioral modeling techniques to transparently assess risk in real-time by analyzing unique authentication data. For example, the system may manage and track transaction information including device type, geolocation, user behavior, and historical fraud data to distinguish genuine transactions from true fraud.

For example, in certain implementations of a risk analytics system, transaction history is maintained for a payment processing agent for tracking and storing transaction information associated with card present and CNP transactions. When a particular transaction is reported as fraudulent, it often must be verified by a human analyst who can then confirm the instance as fraudulent and mark the appropriate verification for that transaction history record. In certain embodiments, administrators can establish static rules that describe how the payment processing system should operate based on identified patterns in transaction data. For example, administrators have been able to use certain known correlations regarding fraudulent transactions to weed out other suspicious transactions.

However, in certain instances, the confidence that an administrator has in these rules is not quantifiable or substantiated by anything other than experience. This is problematic for several reasons. First, when an administrator leaves, the knowledge he or she has gained in order to address or identify fraudulent transactions by sight is gone. Moreover, key insights are being left on the table as the administrator is not able to accurately convey the knowledge he or she has built throughout the years.

Often, based on the suspicion materialized with reference to the static rules installed, a transaction is denied, or further authentication procedures can be invoked. The teachings of the present disclosure present systems and methods for automatically generating rules from historic transaction data to identify signatures of fraudulent activity. In certain embodiments, these signatures are expressed as values of features in a feature vector mapping space. A triggering criteria is established based on the concurrent value of particular ones of these feature vector values, and payment processing actions are triggered upon satisfaction of these criteria in real-time transaction data.

In particular embodiments, a database of historical transaction data is accessed to provide training data for a machine learning model. The training data contains transaction records stored as feature vectors that have been tagged as fraudulent or non-fraudulent. In certain embodiments, a correlation between values of particular features in the database of historical feature vectors is determined. For example, when analyzing numerous feature vectors certain patterns can be distinguished in the feature values for those records associated with fraudulent activity. For example, numerous transactions occurring within a certain time period in a specific region having other specific attributes may be identified as correlating with fraudulent activity. The machine learning algorithm identifies these correlations.

In certain embodiments, various triggering criteria can be established based on the machine learning process. For example, the triggering criteria may specify certain threshold ranges, within which transactions that exhibit those values tend more often than not to be fraudulent. When several of these transaction properties fall within the criteria range, it may provide a strong indication that the activity is fraudulent. For example, the historical training data may show that transactions originating in certain regions of South America against European merchants having a US delivery address within a certain geographic range are correlated with fraudulent activity. The machine learning model establishes these ranges as triggering criteria. Those of ordinary skill in the art will appreciate the wide array of possible values on which to distinguish fraudulent from legitimate transactions.

In certain embodiments, the risk analytics process receives incoming real-time transaction requests and makes decisions on whether to approve or deny those transactions. In certain embodiments, the payment processing system additionally sets that level of authentication that is required for a particular transaction based on attributes of the transaction. Using the established triggering criteria, the payment processing system may receive a request to approve a new transaction that includes detailed attribute information regarding the requesting party, the merchant, account holder, issuing bank, time, geographic region of the purchaser, issuing institution, merchant, delivery address, authentication status of the device, device information, IP address of any user, merchant or institutional devices, currency of the transaction, and various other attributes regarding the transaction. In certain embodiments, the payment processing system applies the triggering criteria to the values of the transaction attributes in order to determine a level of suspicion or legitimacy of the transaction.

Based on the application of the criteria thresholds, the payment processing system may take one or more additional actions. For example, the payment processing system may deny the transaction. As another example, the payment processing system may approve the transaction but log additional information. In certain embodiments, the payment processing system may tag suspicious transactions for later review, such as review by agents. In certain embodiments, the payment processing agent may apply several enhanced authentication schemes in response to determining that the attributes are within the threshold. For example, a two-factor authentication scheme and password authentication may be required in order to approve the transaction. As another example, security questions may be employed along with another authentication scheme. Thus, the amount of security can be increased or reduced in order to meet the needs of the application. In certain embodiments, the threshold criteria can be revised in order to strike a balance between zealous security without burdening the account holder.

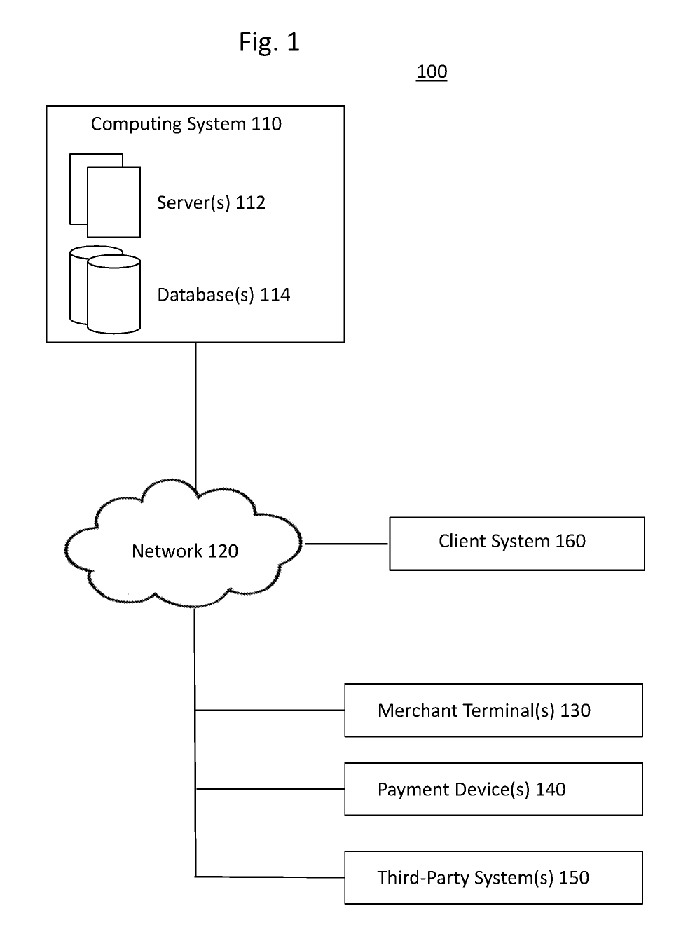

With reference to FIG. 1, a high level block diagram of a computer network 100 is illustrated in accordance with a non-limiting embodiment of the present disclosure. Network 100 includes computing system 110 which is connected to network 120. The computing system 110 includes servers 112 and data stores or databases 114. For example, computing system 110 may host a payment processing server or a risk analytics process for analyzing payment processing data. For example, databases 114 can store transaction history information, such as history information pertaining to transactions and devices. Network 100 also includes client system 160, merchant terminal 130, payment device 140, and third party system 150, which are each also connected to network 120. For example, a user may use peripheral devices connected to client system 160 to initiate e-commerce transactions with vendor websites, such as third party systems 150 or merchant terminals 130. As another example, a user uses a payment device 140 to initiate transactions at merchant terminal 130. In certain embodiments, a payment processing agent is involved in approving each transaction. The steps involved in interfacing with the credit issuing bank are omitted, but can be accomplished through network 120 and computing system 110 and additional computing systems. In certain embodiments, the above described transaction activity is analyzed and stored by computing system 110 in databases 114. Those of ordinary skill in the art will appreciate the wide variety of configurations possible for implementing a risk analytics platform as described in the context of the present disclosure. Computer network 100 is provided merely for illustrative purposes in accordance with a single non-limiting embodiment of the present disclosure.

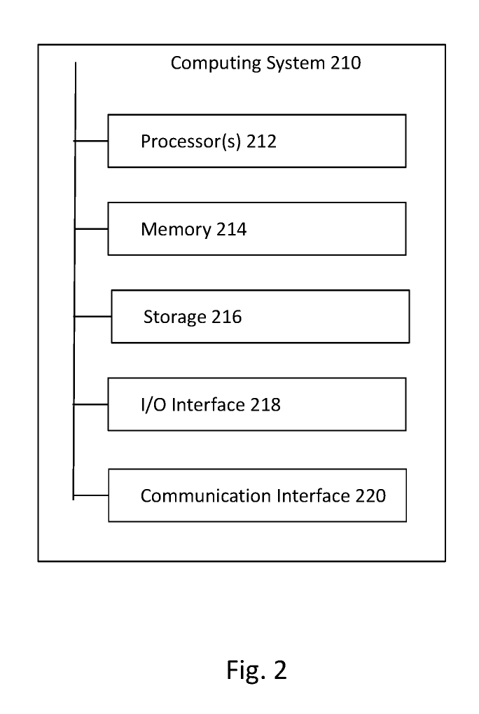

With reference to FIG. 2, a computing system 210 is illustrated in accordance with a non-limiting embodiment of the present disclosure. For example, computing system 210 may implement a payment processing and/or risk analytics platform in connection with the example embodiments described in the present disclosure. Computing system 210 includes processors 212 that execute instructions loaded from memory 214. In some cases, computer program instructions are loaded from storage 216 into memory 214 for execution by processors 212. Computing system 210 additional provides input/output interface 218 as well as communication interface 220. For example, input/output interface 218 may interface with one or more external users through peripheral devices while communication interface 220 connects to a network. Each of these components of computing system 210 are connected on a bus for interfacing with processors 212 and communicating with each other.

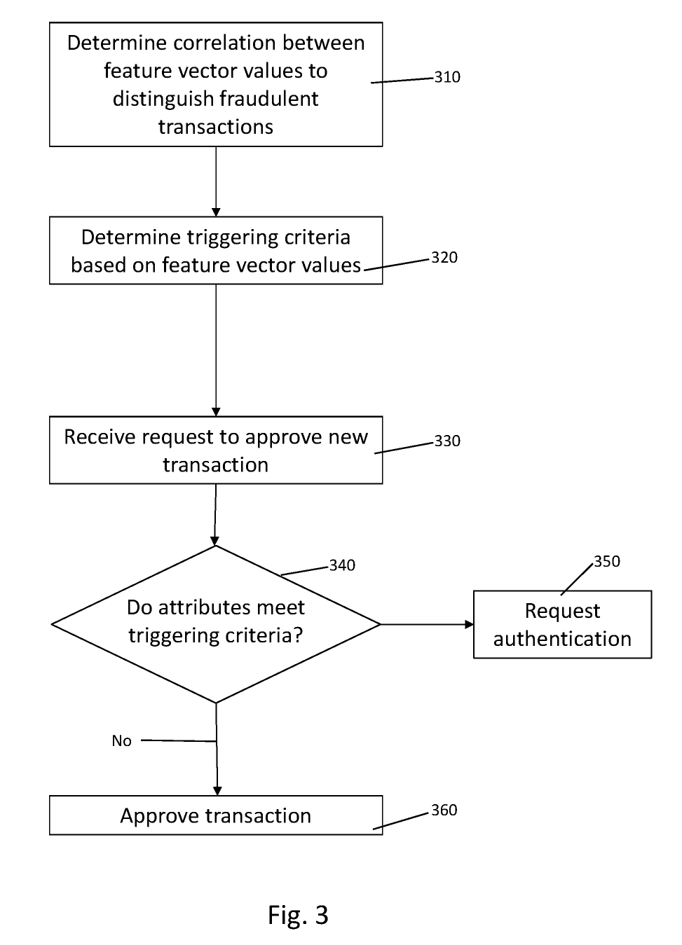

With reference to FIG. 3, a flow chart for identifying fraudulent transactions is illustrated in accordance with a non-limiting embodiment of the present disclosure. At step 310 a correlation between feature vector values is identified to distinguish between fraudulent and legitimate transactions. For example, a database of historical transaction information can be mined to develop a set of training data. The training data may be a set of feature vectors that represent transaction details for a corresponding transaction. For example, the feature vector for a particular transaction may indicate the following non-exhaustive list of details regarding the transaction: requesting party account identifier, requesting party device identifier, merchant identifier, merchant terminal device identifier, product identifier, price, level of authentication required by merchant, account information including the issuing institution, credit information regarding the transacting parties, transaction time, geographic region of the purchaser, geographic region of the issuing institution, geographic region of the merchant, delivery address, authentication status of the device, IP address of any user, merchant or institutional devices involved in the transaction, currency used in the transaction, and the like. In addition, the feature vectors may include information regarding whether the transaction was confirmed fraudulent, suspected fraudulent, or confirmed legitimate. The feature vectors may also have an indication as to whether those transactions were flagged as suspicious or are somehow related to fraudulent activity.

Correlations between feature vectors associated with fraudulent transactions can be identified. For example, any combination of one or more of the above listed feature values can be used to find correlations in the training data that distinguish fraudulent transactions from legitimate transactions.

At step 320, triggering criteria are developed from the determined correlations. For example, triggering criteria may specify specific threshold values or ranges for identifying potentially fraudulent transactions. The machine learning algorithm may automatically develop these criteria with reference to training data and apply them to real-time incoming transaction data. For example, the machine learning algorithm can be trained to identify these correlations. Triggering criteria may specify some additional action or set of actions that the payment processor may take in response to a positive indication as to fraud.

At step 330, a payment processor receives a request to approve a new real-time transaction. For example, a user attempts to initiate an e-commerce transaction using a CNP payment method at a merchant website. The payment request is transmitted to the payment processor along with transaction information including the above listed attributes and values. The payment processor uses the trained machine learning algorithm to check the transaction for suspicion of fraud. The threshold criteria are used to evaluate the level of suspicion to associate with the transaction.

At step 340, the payment processor determines whether the attributes of the new transaction meet the triggering criteria. If the triggering criteria are met, then the payment processor takes additional action at step 350, such as requesting additional authentication measures and delaying approval of the transaction until those authentication measures are satisfied. If the triggering criteria is not met, then the payment processor proceeds to approve the transaction at step 360. In certain embodiments, the transaction may be denied. For example, if the triggering criteria evince a certain range, the transaction may be denied and additional measures for reporting fraud to local authorities can be triggered. For example, various levels of triggering criteria can be employed involving various and seemingly unrelated attributes based on the training of the machine learning algorithm.

For example, one set of criteria may trigger a transaction denial, another set of criteria may trigger enhanced authentication, another set of criteria may trigger relaxed authentication, another set of criteria may trigger approval of the transaction. Each of those criteria may be established with seemingly unrelated transaction attributes after being learned from seemingly unrelated fraudulent or non-fraudulent feature values in the training data. For example, certain signatures in the transaction attributes may indicate that the transaction is trustworthy and signal the payment processor to approve the transaction, even if other criteria are met that would normally block the transaction. In certain embodiments, the criteria can be structured in a hierarchical structure such that certain defined criteria trump other criteria.

In certain embodiments, the machine learning model may learn the appropriate response to take in certain situations based on training data. For example, training data may indicate that transactions where follow-on authentication requests were presented hassled or put out a particular type of user or a user from a particular geographic region, the machine learning model may identify these trends based on additional feature values. For example, the feature value may indicate the customer satisfaction with the transaction or the payment processing agent or card issuing institution in general. Based on these feature values, the machine learning model may identify a set of responses to improve upon or change bad reviews. For example, if a customer feels that too much authentication was requested, the machine learning model may identify a more tolerant triggering criteria for that transaction profile.

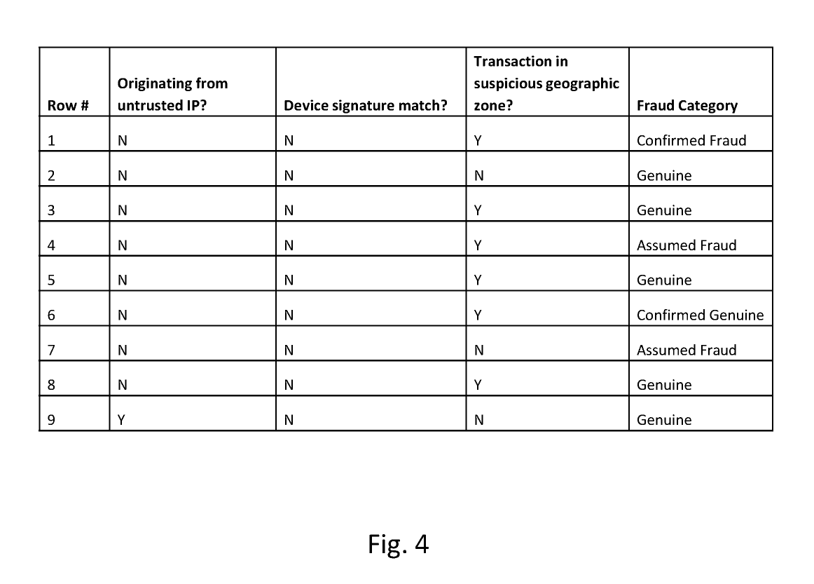

With reference to FIG. 4, a sample set of transaction data is illustrated in accordance with a non-limiting embodiment of the present disclosure. For example, this transaction information may be stored in a historical database of transaction information and converted into feature vectors representing each transaction as training data. With reference to the transaction represented by row 1, the transaction information indicates that the transaction did not originate from a known untrusted IP address, and that the device signature does not match any known fraudulent device signatures. However, the device is in a particular set of suspicious geographic zones that are usually associated with fraud. This particular transaction was tagged as confirmed fraud. Other transactions are tagged confirmed genuine with the authenticity of the transaction is confirmed. Otherwise, the transaction is given an “assumed” category of either assumed fraud or genuine. Those of ordinary skill in the art will appreciate the great number of potential transaction attributes that can be recorded for each transaction. This data will likely end up as training data for a machine learning algorithm to help identify correlations between confirmed and assumed fraudulent transactions based on the other attribute information.

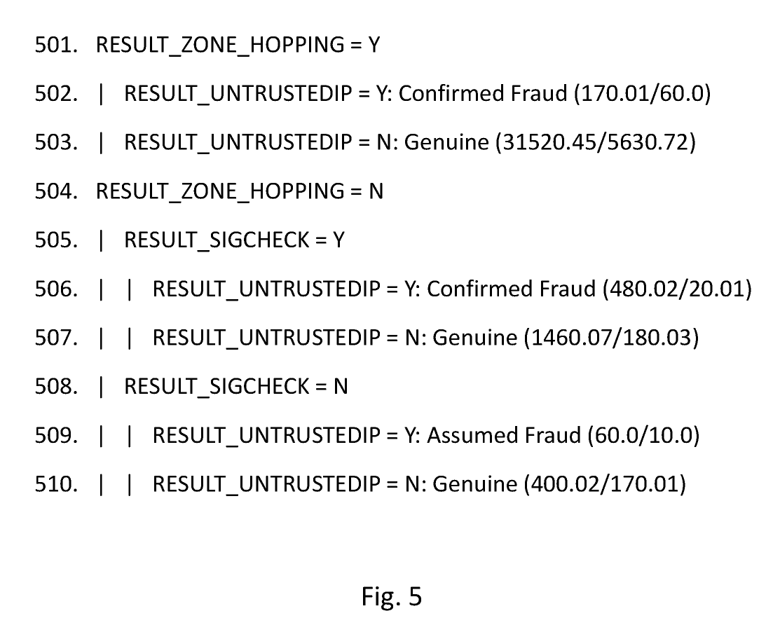

With reference to FIG. 5, pseudocode for an example simplified decision tree is illustrated in accordance with a non-limiting embodiment of the present disclosure. For example, such a decision tree may guide the payment processing system in assessing the propriety of a transaction. For example, such a decision tree may be identified by realizing correlations in the historical transaction data. Those of ordinary skill in the art will appreciate the simplified nature of this decision tree. Many additional attributes and decisions can be accounted for without departing from the scope of the present disclosure.

At line 501, a real time transaction is checked for the zone-hopping attribute. In other words, this attribute checks if the last known transaction from this account or device originated in a different geographic zone. Such an indication may indicate a high probability of fraud. If the zone-hopping transaction attribute is yes, then in line 502, the trustworthiness of the IP address is checked. If the IP address is known to be associated with fraud, then the system can safely categorize the transaction as fraudulent. At line 503, if the IP is not associated with fraud, then the transaction is marked as genuine. At line 505, if the zone-hopping attribute is negative, the device signature is checked against a database of known fraudulent devices. If the device signature is associated with known fraudulent devices and the IP address is untrusted, then the transaction can be confirmed as fraud in line 506. If the device signature is not in the list of known fraudulent devices, but the IP address is in the list of known fraudulent IP addresses, then the payment processing system can assume that the transaction was fraudulent at line 509.

With ever changing fraud patterns it may be difficult for human experts to keep track of all the patterns that are new, resulting in potential loss of revenue and reputation for financial institutions, hence an automated way to identifying these new patterns can be very useful. Rule recommendation can supplement human analyst expertise in identifying patterns in historic data. Also, these rules are based on statistic that can give a measure of confidence in effectiveness of the rule. The identification of genuineness of the transaction, is equally if not more important than identification of fraudulent transaction, since this can help reduce friction in user experience with the confidence in data suggesting no fraud. In this scenario also, rules can be recommended to help identify genuineness of transactions.

The flowcharts and diagrams described herein illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method, comprising:
by a computing device, determining, within a plurality of feature vectors corresponding to a plurality of transactions, a correlation between values of particular features in the plurality of feature vectors that distinguish at least a subset of the transactions as fraudulent, wherein each feature vector comprises a plurality of features having values that describe the feature vector's corresponding transaction;
by the computing device, generating a triggering criteria for identifying suspicious transactions based on the values of the particular features;
by the computing device, in response to receiving a request to approve a new transaction, determining that attributes of the new transaction meet the triggering criteria; and
by the computing device, transmitting a request for authentication of an account holder associated with the new transaction.

2. The method of claim 1, further comprising denying the request to approve the new transaction in response to determining that the attributes of the new transaction meet the triggering criteria.

3. The method of claim 1, wherein the feature vectors are stored in a transaction management system that records transaction information regarding attempted and completed transactions for a card issuing institution.

4. The method of claim 1, wherein the correlation is determined using a machine learning algorithm.

5. The method of claim 1, wherein the plurality of fraudulent transactions correspond to confirmed instances of fraud in a transaction management system.

6. The method of claim 1, wherein the plurality of features for a transaction comprise:
transaction amount;
currency of the transaction; and
location of the transaction.

7. The method of claim 1, wherein the plurality of features for a transaction comprise:
internet protocol address of an initiator of the transaction;
internet protocol address of a merchant associated with the transaction; and
a time of the transaction.

8. The method of claim 1, further comprising:
in response to determining that the attributes of the new transaction meet the triggering criteria, flagging a device associated with initiating the transaction.

9. The method of claim 1, wherein at least one of the plurality of features indicate a number of times that a device associated with initiating the transaction has been identified as being associated with a suspicious transaction.

10. The method of claim 1, wherein the request for authentication comprises a multi-factor authentication scheme.

11. A computer configured to access a storage device, the computer comprising:
a processor; and
a non-transitory, computer-readable storage medium storing computer-readable instructions that when executed by the processor cause the computer to perform:
determining, within a plurality of feature vectors corresponding to a plurality of transactions, a correlation between values of particular features in the plurality of feature vectors that distinguish at least a subset of the transactions as fraudulent, wherein each feature vector comprises a plurality of features having values that describe the feature vector's corresponding transaction;
generating a triggering criteria for identifying suspicious transactions based on the values of the particular features;
in response to receiving a request to approve a new transaction, determining that attributes of the new transaction meet the triggering criteria;
flagging a device associated with initiating the new transaction as suspicious; and
if the device has been previously flagged as suspicious, denying the request to approve the new transaction; and
if the device has not been previously flagged as suspicious, transmitting a request for authentication of an account holder associated with the new transaction.

12. The computer of claim 11, wherein the computer-readable instructions further cause the computer to perform:
denying the request to approve the new transaction in response to determining that the attributes of the new transaction meet the triggering criteria.

13. The computer of claim 11, wherein the feature vectors are stored in a transaction management system that records transaction information regarding attempted and completed transactions for a card issuing institution.

14. The computer of claim 11, wherein the correlation is determined using a machine learning algorithm.

15. The computer of claim 11, wherein the plurality of transactions comprise fraudulent transactions that correspond to confirmed instances of fraud in a transaction management system.

16. The computer of claim 11, wherein the plurality of features for a transaction comprise:
transaction amount;
currency of the transaction; and
location of the transaction.

17. The computer of claim 11, wherein the plurality of features for a transaction comprise:
internet protocol address of an initiator of the transaction;
internet protocol address of a merchant associated with the transaction; and
a time of the transaction.

18. The computer of claim 11, wherein the computer-readable instructions further cause the computer to perform:
in response to determining that the attributes of the new transaction meet the triggering criteria, blocking transaction requests associated with the device.

19. The method of claim 1, wherein at least one of the plurality of features indicate a number of times that the device associated with initiating the new transaction has been identified as being associated with a suspicious transaction.

20. A non-transitory computer-readable medium having instructions stored thereon that is executable by a computing system to perform operations comprising:
determining, within a plurality of feature vectors corresponding to a plurality of transactions, a correlation between values of particular features in the plurality of feature vectors that distinguish at least a subset of the transactions as fraudulent, wherein each feature vector comprises a plurality of features having values that describe the feature vector's corresponding transaction;
generating a triggering criteria for identifying suspicious transactions based on the values of the particular features;
in response to receiving a request to approve a new transaction, determining that attributes of the new transaction meet the triggering criteria;
determining a suspicion score for a device associated with initiating the new transaction, wherein the suspicion score is based on a number of times that the device has been previously flagged as suspicious and other devices that the device is related to that have been previously flagged as suspicious.
